(19) United States
(12) Patent Application Publication
(10) Pub. No.: US 2018/0157338 A1
(43) Pub. Date: Jun. 7, 2018

(54) METHOD FOR ASSEMBLING KEYBOARD DEVICE

(71) Applicant: PRIMAX ELECTRONICS LTD., Taipei (TW)

(72) Inventors: CHUN-YUAN LIU, Taipei (TW); TSU-YI CHEN, Taipei (TW)

(21) Appl. No.: 15/433,195

(22) Filed: Feb. 15, 2017

(30) Foreign Application Priority Data
Dec. 2, 2016 (TW) 105139909

(51) Int. Cl. G06F 3/02; B23K 26/22

(52) U.S. Cl. CPC G06F 3/0213; B23K 2201/36; B23K 26/22

(57) ABSTRACT

A method for assembling a keyboard device includes the following steps. Firstly, a keyboard base and a cursor moving module are provided. Then, the cursor moving module is initially assembled with the keyboard base according to a supporting plate of the cursor moving module. Then, a laser welding process is performed on a junction between the supporting plate and the keyboard base. Consequently, the cursor moving module and the keyboard base are combined together. By the assembling method of the present invention, no protrusion structures are formed on the inner surface of the keyboard base. Consequently, the thickness of the keyboard device is not decreased, and the slimness of the keyboard device is achieved.

### FIELD OF THE INVENTION

The present invention relates to a method for assembling a keyboard device, and more particularly to a method for assembling a keyboard device with a cursor moving module.

### BACKGROUND OF THE INVENTION

Generally, the widely-used peripheral input device of a computer system includes for example a mouse device, a keyboard device, a trackball device, or the like. Via the keyboard device, characters and symbols can be inputted into the computer system directly. As a consequence, most users and most manufacturers of input devices pay much attention to the development of keyboard devices.

FIG. 1 is a schematic top view illustrating the outer appearance of a conventional keyboard device. As shown in FIG. 1, plural keys 10 and a cursor moving module 11 are exposed to a surface of the conventional keyboard device 1. These keys 10 are classified into several types, e.g. ordinary keys 101, numeric keys 102 and function keys 103. When one of these keys 10 is depressed by the user's finger, a corresponding signal is issued to the computer, and thus the computer executes a function corresponding to the depressed key. For example, when an ordinary key 101 is depressed, a corresponding English letter or symbol is inputted into the computer. When a numeric key 102 is depressed, a corresponding number is inputted into the computer. In addition, the function keys 103 (F1-F12) can be programmed to provide various functions. The cursor moving module 11 is arranged between the plural keys 10. When the user's finger is placed on the cursor moving module 11 and moved on the cursor moving module 11, a cursor of a computer (not shown) is correspondingly moved. For example, the conventional keyboard device 1 is a keyboard device for a notebook computer.

Moreover, the conventional keyboard device 1 comprises a keyboard base (not shown). The cursor moving module 11 is fixed on the keyboard base. Generally, the cursor moving module 11 is fixed on the keyboard base through screws or rivets. When the cursor moving module 11 is fixed on the keyboard base through screws, the screws are penetrated through the keyboard base and protruded from the inner surface of the keyboard base. Under this circumstance, the interior of the keyboard base has an accommodation space for accommodating the protruded screws. Similarly, when the cursor moving module 11 is fixed on the keyboard base through rivets, protrusion structures are formed on the inner surface of the keyboard base. Under this circumstance, the interior of the keyboard base has an accommodation space for accommodating the protrusion structures. In other words, the uses of the screws or rivets increase the thickness of the keyboard device, and are detrimental to the slimness of the keyboard device.

Therefore, there is a need of providing a method for assembling a keyboard device without increasing the thickness of the keyboard device.

### SUMMARY OF THE INVENTION

An object of the present invention provides a method for assembling a keyboard device without increasing the thickness of the keyboard device.

In accordance with an aspect of the present invention, there is provided a method for assembling a keyboard device. The method includes the following steps. In a step (A), a keyboard base is provided. In a step (B), a cursor moving module is provided. In a step (C), the cursor moving module is initially assembled with the keyboard base according to a supporting plate of the cursor moving module. In a step (D), a laser welding process is performed on a junction between the supporting plate and the keyboard base, so that the cursor moving module and the keyboard base are combined together.

From the above descriptions, the present invention provides a method for assembling a keyboard device. The supporting plate of the cursor moving module and the keyboard base are initially assembled with the keyboard base through the inherent structure of the supporting plate. In other words, it is not necessary to use additional components to fix the supporting plate and the keyboard base. Then, a laser welding process is performed on a junction between the supporting plate and the keyboard base. Consequently, the cursor moving module is securely fixed on the keyboard base. By the assembling method of the present invention, no protrusion structures are formed on the inner surface of the keyboard base. Consequently, the thickness of the keyboard device is not decreased, and the slimness of the keyboard device is achieved.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view illustrating the outer appearance of a conventional keyboard device;

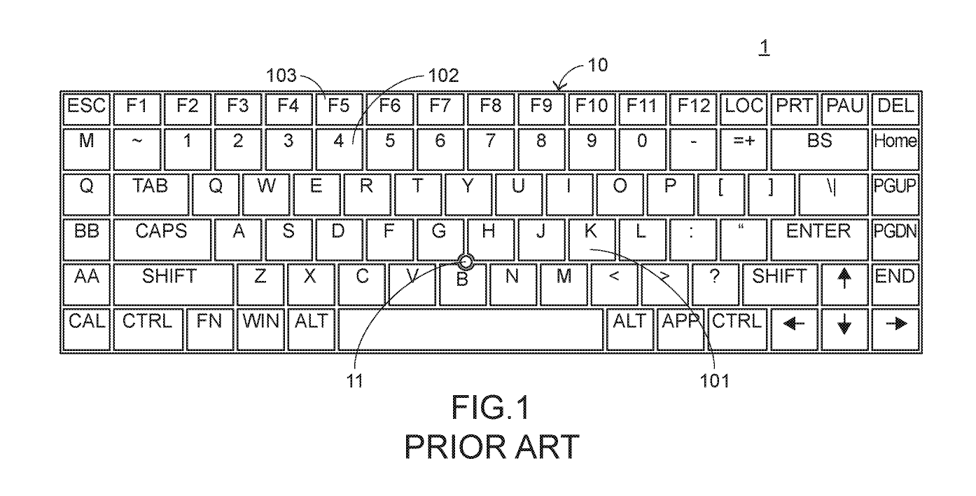

FIG. 2 is a schematic exploded view illustrating a portion of a keyboard device according to a first embodiment of the present invention;

FIG. 3 is a flowchart illustrating a method for assembling a keyboard according to the first embodiment of the present invention;

FIG. 4 is a schematic perspective view illustrating a portion of the keyboard device according to the first embodiment of the present invention;

FIG. 5 is a schematic cross-sectional view illustrating a portion of the keyboard device according to the first embodiment of the present invention;

FIG. 6 is a schematic exploded view illustrating a portion of a keyboard device according to a second embodiment of the present invention;

FIG. 7 is a flowchart illustrating a method for assembling a keyboard according to a second embodiment of the present invention;

FIG. 8 is a schematic perspective view illustrating a portion of the keyboard device according to the second embodiment of the present invention; and

FIG. 9 is a schematic cross-sectional view illustrating a portion of the keyboard device according to the second embodiment of the present invention.

### DETAILED DESCRIPTION OF THE PREFERRED EMBODIMENT

For overcoming the drawbacks of the conventional technology, the present invention provides a method for assembling a keyboard device without increasing the volume of the keyboard device.

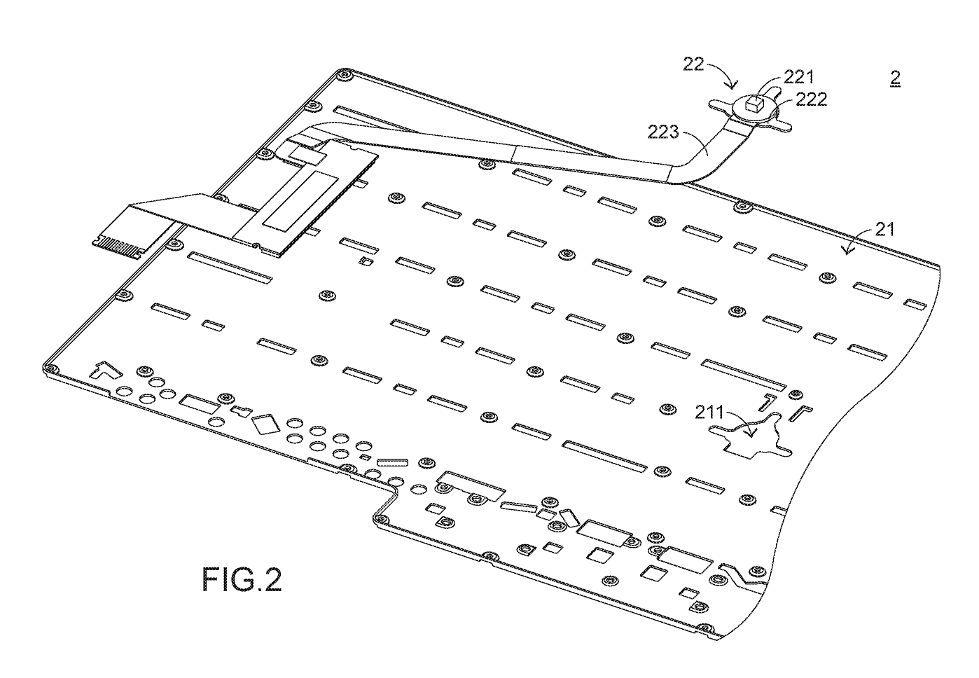

FIG. 2 is a schematic exploded view illustrating a portion of a keyboard device according to a first embodiment of the present invention. For succinctness, only a keyboard base 21 and a cursor moving module 22 of the keyboard device 2 are shown. The keyboard base 21 comprises an opening 211. The cursor moving module 22 comprises a sensing element 221, a supporting plate 222 and a wiring part 223. The sensing element 221 is exposed to a top surface of the keyboard device 2. When the user's finger is placed on the sensing element 221 and moved on the sensing element 221, the sensing element 221 can detect the movement of the finger. According to the detected movement of the finger, a cursor of a computer (not shown) in communication with the keyboard device 2 is correspondingly moved. The supporting plate 222 is located under the sensing element 221 for supporting the sensing element 221 and the wiring part 223. Moreover, the supporting plate 222 is connected with the keyboard base 21. The wiring part 223 is electrically connected with the sensing element 221. The wiring part 223 is penetrated through the opening 211 of the keyboard base 21. As shown in FIG. 2, the shape of the opening 221 matches the shape of the supporting plate 222.

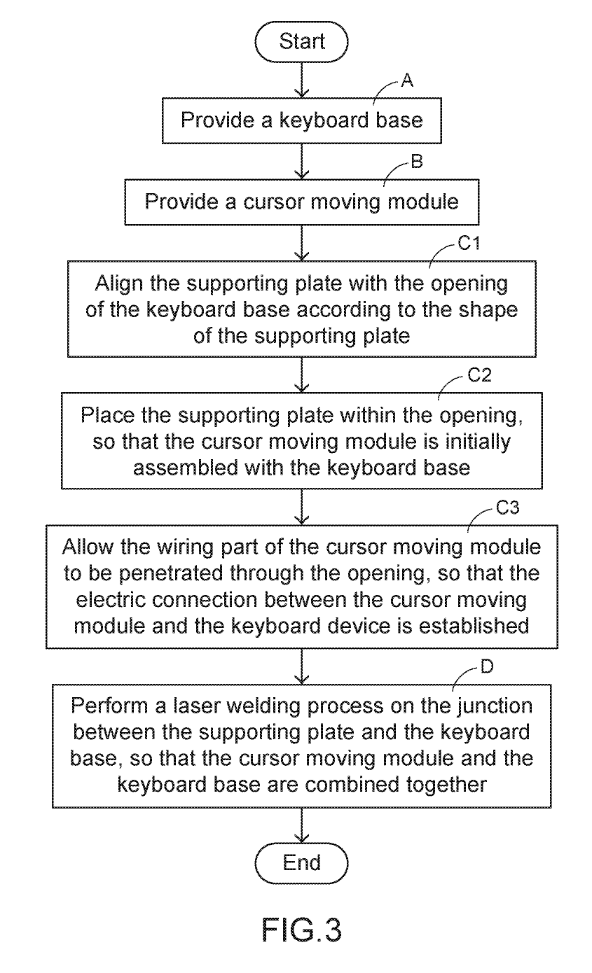

A method for assembling the keyboard of the present invention will be described as follows. FIG. 3 is a flowchart illustrating a method for assembling a keyboard according to a first embodiment of the present invention. The assembling method comprises the following steps.

In a step A, a keyboard base is provided.

In a step B, a cursor moving module is provided.

In a step C1, the supporting plate is aligned with the opening of the keyboard base according to the shape of the supporting plate.

In a step C2, the supporting plate is placed within the opening, so that the cursor moving module is initially assembled with the keyboard base.

In a step C3, the wiring part of the cursor moving module is penetrated through the opening, so that the electric connection between the cursor moving module and the keyboard device is established.

In a step D, a laser welding process is performed on the junction between the supporting plate and the keyboard base. Consequently, the cursor moving module and the keyboard base are combined together.

The operations of the method for assembling the keyboard will be described as follows. Please refer to FIGS. 2 and 3. Firstly, in the step A, the keyboard base 21 is provided. The keyboard base 21 comprises the opening 211. The shape of the opening 211 matches the shape of the supporting plate 222. Then, in the step B, a cursor moving module 22 is provided. The cursor moving module 22 has the above structure. In the step C1, the supporting plate 222 is aligned with the opening 211 of the keyboard base 21, wherein the shapes of the supporting plate 222 and the opening 211 are complementary to each other. Then, in the step C2, the supporting plate 222 is placed within the opening 221. Consequently, the cursor moving module 22 is initially assembled with the keyboard base 21. Then, in the step C3, the wiring part 223 of the cursor moving module 22 is penetrated through the opening 211, and the wiring part 223 is inserted into a connection port (not shown) of the keyboard device 2. Consequently, the electric connection between the cursor moving module 22 and the keyboard device 2 is established. After the step C3 is completed, the cursor moving module 22 is powered by the keyboard device 2. Consequently, the sensing element 221 is enabled.

In this embodiment, the step C3 is performed after the step C2 is performed. It is noted that the sequence of the steps C2 and C3 is not restricted. For example, in another embodiment, the step C2 is performed after the step C3 is performed.

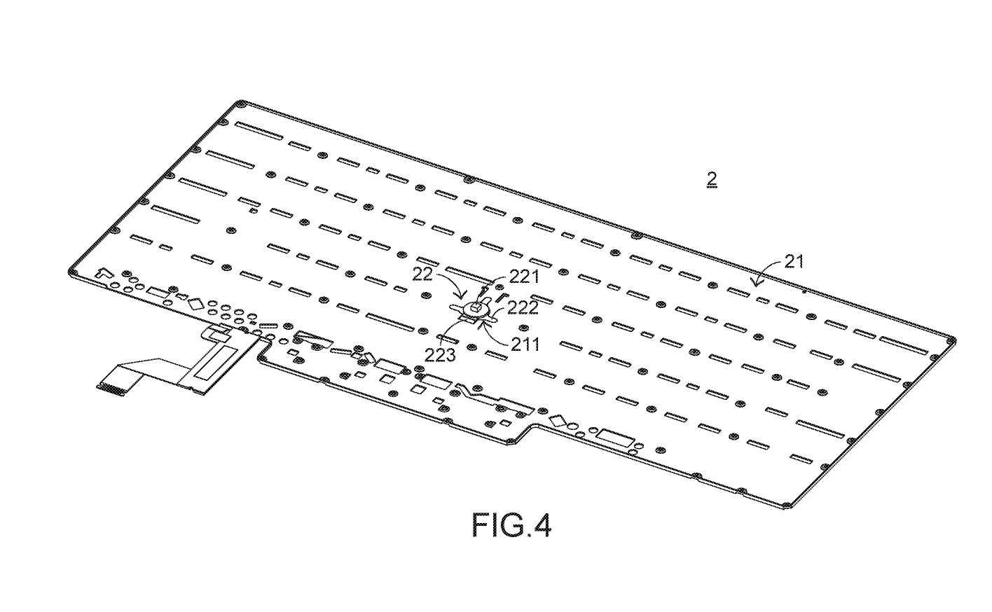

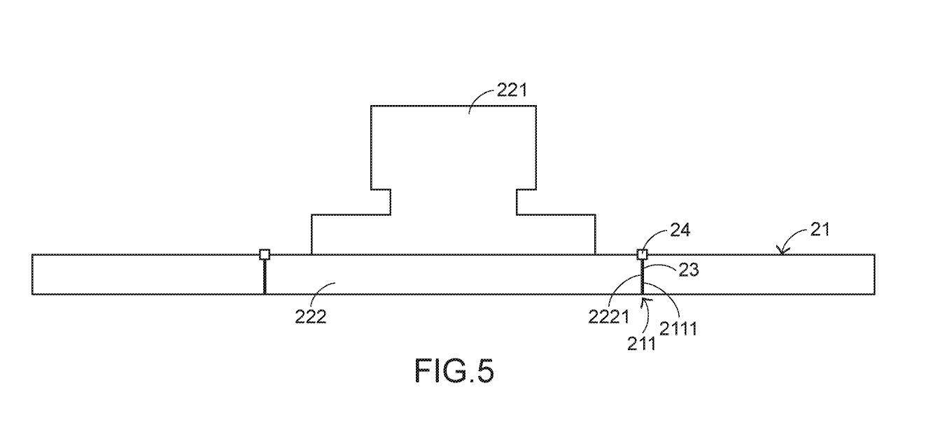

Please refer to FIGS. 3, 4 and 5. FIG. 4 is a schematic perspective view illustrating a portion of the keyboard device according to the first embodiment of the present invention. FIG. 5 is a schematic cross-sectional view illustrating a portion of the keyboard device according to the first embodiment of the present invention. The initial connecting relationship between the cursor moving module 22 and the keyboard base 21 is shown in FIGS. 4 and 5. In this embodiment, the junction 23 between the supporting plate 222 and the keyboard base 21 is the contact area between a sidewall 2221 of the supporting plate 222 and an inner wall of the opening 211. In the step D, the laser welding process is performed on the junction 23 between the supporting plate 222 and the keyboard base 21. Consequently, the cursor moving module 22 and the keyboard base 21 are combined together. After the contact area between the sidewall 2221 of the supporting plate 222 and the inner wall of the opening 211 are treated by the laser welding process, a welded joint 24 with the shape of the supporting plate 222 is formed between the supporting plate 222 and the opening 221. Under this circumstance, as shown in FIG. 5, the cursor moving module 22 and the keyboard base 21 are combined together. In this embodiment, the supporting plate 222 and the keyboard base 21 are made of the same metallic material in order to facilitate the laser welding process.

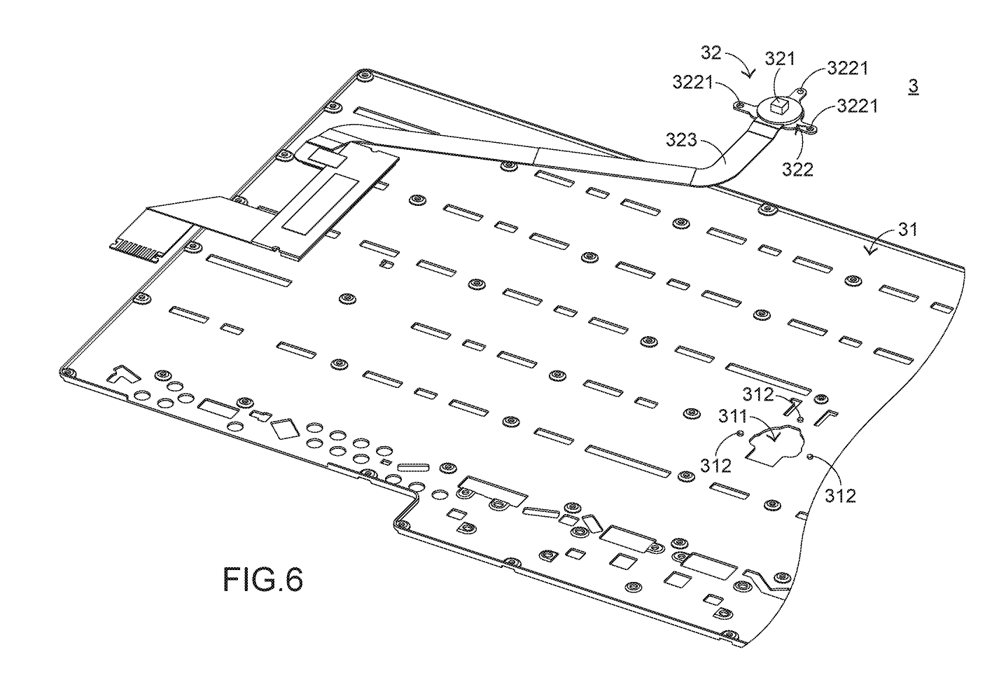

The present invention further comprises a second embodiment, which is distinguished from the first embodiment. FIG. 6 is a schematic exploded view illustrating a portion of a keyboard device according to a second embodiment of the present invention. For succinctness, only a keyboard base 31 and a cursor moving module 32 of the keyboard device 3 are shown. The keyboard base 31 comprises an opening 311 and plural positioning posts 312. The plural positioning posts 312 are arranged near the opening 311. The cursor moving module 32 comprises a sensing element 321, a supporting plate 322 and a wiring part 323. The sensing element 321 is exposed to a top surface of the keyboard device 3. When the user's finger is moved on the sensing element 321, the sensing element 321 can detect the movement of the finger. According to the detected movement of the finger, a cursor of a computer (not shown) in communication with the keyboard device 3 is correspondingly moved. The supporting plate 322 is located under the sensing element 321 for supporting the sensing element 321 and the wiring part 323. Moreover, the supporting plate 322 is connected with the keyboard base 31. The supporting plate 322 comprises plural positioning holes 3221. The plural positioning holes 3221 are aligned with the plural positioning posts 312, respectively. The wiring part 323 is electrically connected with the sensing element 321. The wiring part 323 is penetrated through the opening 311 of the keyboard base 31.

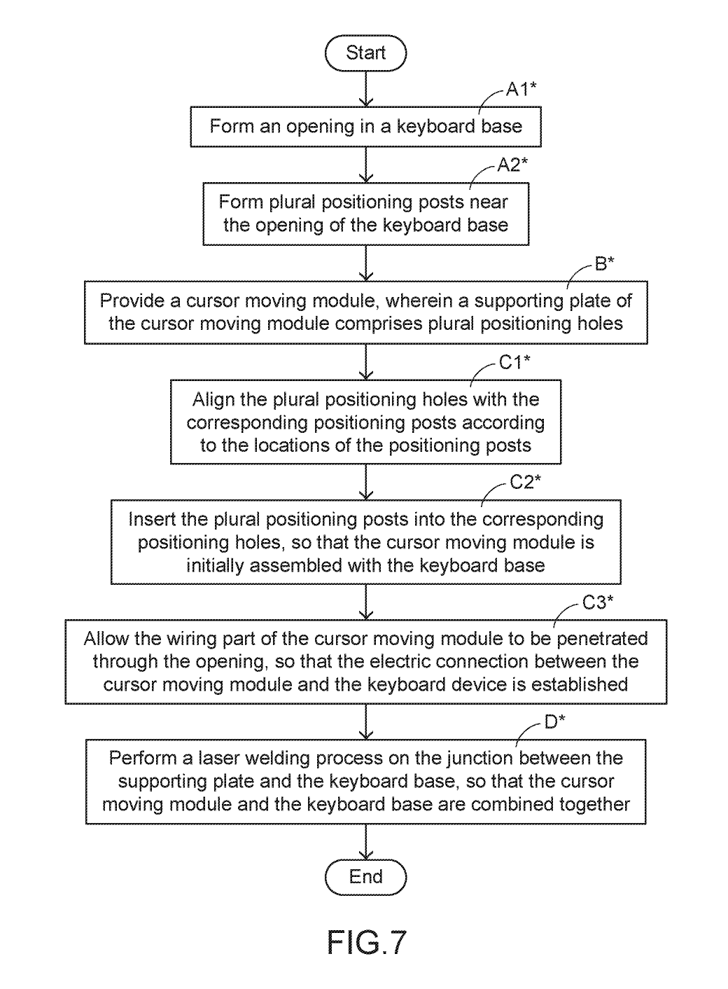

FIG. 7 is a flowchart illustrating a method for assembling a keyboard according to a second embodiment of the present invention. The assembling method comprises the following steps.

In a step A1*, an opening is formed in a keyboard base.

In a step A2*, plural positioning posts are arranged near the opening of the keyboard base.

In a step B*, a cursor moving module is provided, wherein a supporting plate of the cursor moving module comprises plural positioning holes.

In a step C1*, the plural positioning holes are aligned with the corresponding positioning posts according to the locations of the positioning posts.

In a step C2*, the plural positioning posts are inserted into the corresponding positioning holes, so that the cursor moving module is initially assembled with the keyboard base.

In a step C3*, the wiring part of the cursor moving module is penetrated through the opening, so that the electric connection between the cursor moving module and the keyboard device is established.

In a step D*, a laser welding process is performed on the junction between the supporting plate and the keyboard base. Consequently, the cursor moving module and the keyboard base are combined together.

The operations of the method for assembling the keyboard will be described as follows. Please refer to FIGS. 6 and 7. Firstly, in the step A1*, an opening 311 is formed in a keyboard base 31. Then, in the step A2*, plural positioning posts 312 are arranged near the opening 311 of the keyboard base 31. Then, in the step B*, a cursor moving module 32 is provided. The cursor moving module 32 has the above structure. Then, in the step C1*, the plural positioning holes 3221 of the supporting plate 322 are aligned with the corresponding positioning posts 312 of the keyboard base 31. Then, in the step C2*, the plural positioning posts 312 are inserted into the corresponding positioning holes 3221, so that the cursor moving module 32 is initially assembled with the keyboard base 31. Then, in the step C3*, the wiring part 323 of the cursor moving module 32 is penetrated through the opening 311, and the wiring part 323 is inserted into a connection port (not shown) of the keyboard device 3. Consequently, the electric connection between the cursor moving module 32 and the keyboard device 3 is established.

In this embodiment, the step A2* is performed after the step A1* is performed. It is noted that the sequence of the steps A1* and A2* is not restricted. For example, in another embodiment, plural positioning posts are firstly formed on the keyboard base, and then an opening is formed near the plural positioning posts.

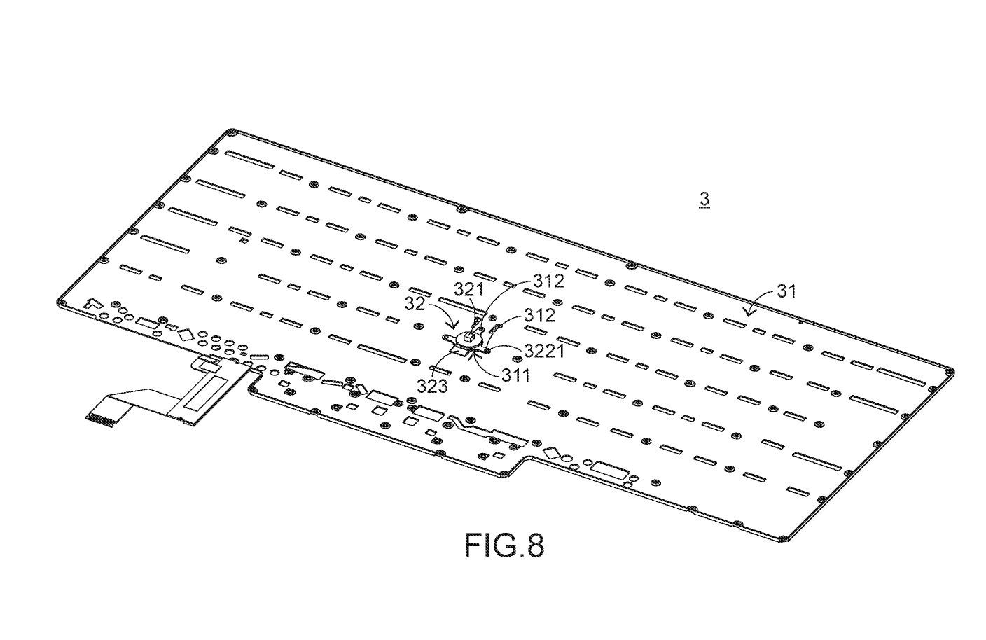

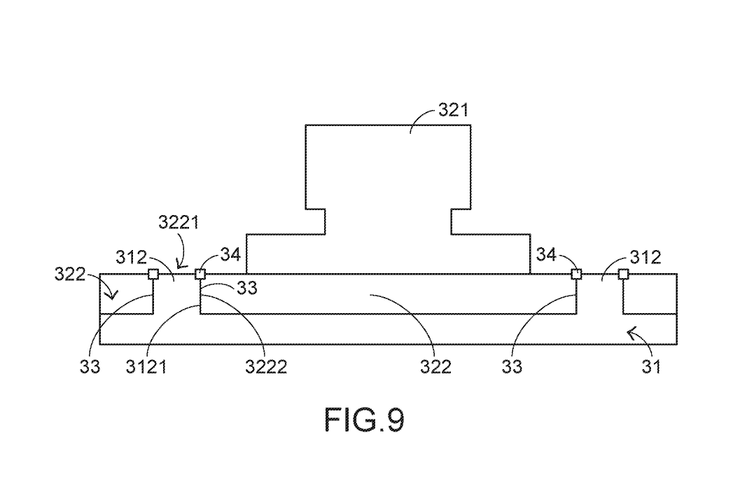

Please refer to FIGS. 7, 8 and 9. FIG. 8 is a schematic perspective view illustrating a portion of the keyboard device according to the second embodiment of the present invention. FIG. 9 is a schematic cross-sectional view illustrating a portion of the keyboard device according to the second embodiment of the present invention. The initial connecting relationship between the cursor moving module 32 and the keyboard base 31 is shown in FIGS. 8 and 9. In this embodiment, the junction 33 between the supporting plate 322 and the keyboard base 31 includes the contact areas between the sidewalls 3121 of the plural positioning posts 312 and the inner walls 3222 of the corresponding positioning holes 3221. In the step D*, the laser welding process is performed on the junction 33 between the supporting plate 322 and the keyboard base 31. Consequently, the cursor moving module 32 and the keyboard base 31 are combined together. After the contact area between the sidewalls 3121 of the plural positioning posts 312 and the inner walls 3222 of the corresponding positioning holes 3221 are treated by the laser welding process, plural welded joints 34 with the shapes of the openings 3221 are formed between the positioning posts 312 and the positioning holes 3221. Under this circumstance, as shown in FIG. 9, the cursor moving module 32 and the keyboard base 31 are combined together.

From the above descriptions, the present invention provides a method for assembling a keyboard device. The supporting plate of the cursor moving module and the keyboard base are initially assembled with the keyboard base through the inherent structure of the supporting plate. In other words, it is not necessary to use additional components to fix the supporting plate and the keyboard base. Then, a laser welding process is performed on a junction between the supporting plate and the keyboard base. Consequently, the cursor moving module is securely fixed on the keyboard base. By the assembling method of the present invention, no protrusion structures are formed on the inner surface of the keyboard base. Consequently, the thickness of the keyboard device is not decreased, and the slimness of the keyboard device is achieved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all modifications and similar structures.

What is claimed is:

1. A method for assembling a keyboard device, the method comprising steps of:
(A) providing a keyboard base;
(B) providing a cursor moving module;
(C) initially assembling the cursor moving module with the keyboard base according to a supporting plate of the cursor moving module; and
(D) performing a laser welding process on a junction between the supporting plate and the keyboard base, so that the cursor moving module and the keyboard base are combined together.

2. The method according to claim 1, wherein the step (C) comprises steps:
(C1) aligning the supporting plate with an opening of the keyboard base according to a shape of the supporting plate, wherein a shape of the opening matches the shape of the supporting plate; and
(C2) placing the supporting plate within the opening, so that the cursor moving module is initially assembled with the keyboard base, wherein the junction is a contact area between a sidewall of the supporting plate and an inner wall of the opening.

3. The method according to claim 2, wherein the step (C) further comprises a step (C3) of penetrating a wiring part of the cursor moving module through the opening, so that an electric connection between the cursor moving module and the keyboard device is established.

4. The method according to claim 2, wherein in the step (D), the contact area between the sidewall of the supporting plate and the inner wall of the opening are treated by the laser welding process, so that a welded joint is formed between the supporting plate and the opening and the cursor moving module and the keyboard base are combined together.

5. The method according to claim 1, wherein the step (A) comprises steps of:
(A1) forming an opening in the keyboard base; and
(A2) forming plural positioning posts near the opening of the keyboard base.

6. The method according to claim 5, wherein in the step (B), the supporting plate comprises plural positioning holes corresponding to the plural positioning posts.

7. The method according to claim 6, wherein the step (C) comprises steps of:
(C1) aligning the plural positioning holes with the corresponding positioning posts according to locations of the positioning posts; and
(C2) inserting the plural positioning posts into the corresponding positioning holes, so that the cursor moving module is initially assembled with the keyboard base, wherein the junction includes contact areas between sidewalls of the plural positioning posts and inner walls of the corresponding positioning holes.

8. The method according to claim 7, wherein the step (C) further comprises a step (C3) of penetrating a wiring part of the cursor moving module through the opening, so that an electric connection between the cursor moving module and the keyboard device is established.

9. The method according to claim 7, wherein in the step (D), the contact areas between the sidewalls of the plural positioning posts and the inner walls of the corresponding positioning holes are treated by the laser welding process, so that welded joints are formed between the plural positioning posts and the corresponding positioning holes and the cursor moving module and the keyboard base are combined together.
